(19) United States
(12) Patent Application Publication
(10) Pub. No.: US 2026/0222206 A1
(43) Pub. Date: Jul. 30, 2026

(54) A QUANTUM TOKEN GENERATION AND VERIFICATION SYSTEM AND METHOD

(71) Applicant: MASTERCARD INTERNATIONAL INCORPORATED, Purchase, NY (US)

(72) Inventor: Mehrdad MALEKI, Maynooth (IE)

(21) Appl. No.: 19/147,596

(22) PCT Filed: Nov. 6, 2023
(86) PCT No.: PCT/US2023/036855

§ 371 Date: Jul. 11, 2025

(30) Foreign Application Priority Data
Jan. 12, 2023 (GB) 2300498.9

(51) Int. Cl. H04L 9/32; H04L 9/08

(52) U.S. Cl. CPC H04L 9/3213; H04L 9/0852

(57) ABSTRACT

A quantum token generation method using computing system comprising a quantum computer in communication with a classical computer is provided. The method comprising the steps of: generating, using the classical computer, a unique identifier comprising f portions; determining, using the classical computer, a secret-key quantum circuit comprising n qubits; generating, using the classical computer and the quantum computer, a classical description of the unique identifier using the secret-key quantum circuit; wherein the classical description comprises n portions; generating, using an n-qubit quantum circuit of the quantum computer, a quantum state based on the classical description of the unique identifier; and outputting, using the classical computer, a quantum token, the quantum token comprising: the unique identifier; and the quantum state.

### CROSS REFERENCE TO RELATED APPLICATION

This application claims the benefit of United Kingdom Patent Application No. 2300498.9, which was filed on Jan. 12, 2023, the entire contents of which are hereby incorporated by reference for all purposes.

### TECHNICAL FIELD

The present disclosure relates to quantum computing. In particular, the present disclosure relates to a system and method for generating and verifying a quantum token using a quantum computer and a classical computer.

### BACKGROUND

Counterfeit money or currency is currency produced in an attempt to imitate real currency in order to deceive a recipient of the counterfeit money. Counterfeit money may take the form of a banknote that has been produced without the legal sanction of a state or government. Furthermore, counterfeit electronic money may exist which is not associated with an equivalent amount of real money. Counterfeit money has substantial effects on society, including reducing the value of real money, increasing inflation, and decreasing the acceptability of money.

Anti-counterfeiting measures are costly and require substantial effort. An example anti-counterfeiting measure for banknotes includes the use of raised intaglio which allows users to spot forged banknotes.

The present disclosure has been devised to mitigate or overcome at least some of the above-mentioned problems.

### SUMMARY OF THE DISCLOSURE

In accordance with a first aspect of the present disclosure, there is provided a quantum token generation method using a computing system comprising a quantum computer in communication with a classical computer, the method comprising the steps of: generating, using the classical computer, a unique identifier; determining, using the classical computer, a secret-key quantum circuit comprising n qubits; generating, using the classical computer and the quantum computer, a classical description of the unique identifier using the secret-key quantum circuit; wherein the classical description comprises n portions; generating, using the classical computer and the quantum computer, an n-qubit quantum state based on the classical description of the unique identifier; and outputting, using the classical computer, a quantum token, the quantum token comprising: the unique identifier; and the n-qubit quantum state.

The quantum token generation method of the present disclosure may generate a quantum token comprising a unique identifier, such as a unique serial number, and a quantum state. Advantageously, due to the no-cloning theorem, the quantum state may not be copied or forged, because doing so may, for example, collapse the quantum state into an eigenstate. Accordingly, quantum tokens generated by the quantum token generation method of the present disclosure may advantageously provide a currency that is immune to forgery.

In some embodiments, the classical description comprises n portions, and generating the classical description comprises: generating a kth portion of the classical description by: initialising the n qubits of the secret-key quantum circuit according to a kth portion of the unique identifier; executing the secret-key quantum circuit; and measuring the secret-key quantum circuit; and combining the n portions. In this way, each of the portions of the classical description may be generated based on a respective portion of the unique identifier, such that the classical description is dependent on the unique identifier. The secret-key quantum circuit may be known only to an operator and as such, additional security may be provided since only the operator is able to reproduce the classical description based on the unique identifier.

In some embodiments, generating the n-qubit quantum state comprises: determining, by the classical computer, one or more computational bases based on the classical description; generating, by the quantum computer, an n-qubit quantum circuit based on the one or more computational bases; and executing, by the quantum computer, the n-qubit quantum circuit so as to generate the n-qubit quantum state. In this way, the n-qubit quantum state may be generated based on the classical description, which is itself generated using a secret-key quantum circuit known only to the operator. In this way, the n-qubit quantum state associated with a particular unique identifier may be reproducible by the operator only. Advantageously, the quantum token may be more secure.

In some embodiments, determining the one or more computational bases comprises: comparing, by the classical computer, each portion of n portions of the classical description to a computational basis key comprising a plurality of computational bases; and selecting, for each portion of the plurality of portions of the classical description, a respective computational basis. In this way, the quantum state may be generate based on a pre-determined library of computational basis keys. Advantageously, the computational bases may be more easily generated.

In some embodiments, generating the quantum circuit comprises: preparing, by the quantum computer, each qubit of the n-quantum circuit in a computational basis corresponding to a respective portion of the classical description; wherein the i^{th} qubit is initialised in the computational basis corresponding to the i^{th} portion of the classical description. In this way, the quantum state may be dependent on the classical description, which is itself known or reproducible by the operator only. Advantageously, the quantum state may be more securely generated.

In some embodiments, generating the unique identifier comprises randomly selecting a unique identifier. In some embodiments, the unique identifier is distinct from a plurality of pre-existing unique identifiers. In this way, each quantum token may have a distinct identifier, which may ensure that only a single copy of each quantum token exists.

In some embodiments, the quantum token generation method further comprises: storing, using the classical computer, the unique identifier in the plurality of pre-existing unique identifiers. In this way, the unique identifiers may be more easily tracked, which may advantageously provide a means for determining whether a unique identifier is forged.

In some embodiments, determining the secret-key quantum circuit comprises: randomly selecting, by the classical computer, the secret-key quantum circuit from a plurality of pre-existing quantum circuits. In this way, computational resources may be saved because the secret-key quantum circuit may be selected from pre-generated quantum circuits.

In some embodiments, determining the secret-key quantum circuit comprises: randomly generating, by the classical computer, the unique secret-key quantum circuit that is distinct from a plurality of pre-existing quantum circuits. In this way, it may be more difficult for a malicious party to reproduce a quantum state, because it may be more difficult for the malicious party to guess which secret-key quantum circuit is used to generate the classical description.

In some embodiments, the quantum token generation method further comprises: storing, by the classical computer, an indication that the secret-key quantum circuit is associated with the unique identifier. In this way, the quantum token may be more easily verified because a record of which secret-key quantum circuit was used to generate a quantum state would be known.

In some embodiments, the unique identifier is a k-bit binary string serial number. In some embodiments, the classical description is a k×n bit binary string.

In accordance with a second aspect of the present disclosure, there is provided a quantum token verification method using a computing system comprising a classical computer in communication with a quantum computer, the method comprising the steps of: receiving, at the classical computer, a quantum token, the quantum token comprising: a unique identifier; and an n-qubit quantum state; determining, by the classical computer, that the unique identifier is real; selecting, by the classical computer, a secret-key quantum circuit; generating, by the classical computer and the quantum computer, a classical description of the unique identifier using the secret-key quantum circuit; determining, by the classical computer, one or more computational bases based on the classical description of the unique identifier; generating, by the quantum computer, a real n-qubit quantum state based on the classical description of the unique identifier and the one or more computational bases; determining, by the quantum computer, a real measurement of the real n-qubit quantum state using the one or more computational bases; determining, by the quantum computer, a token measurement of the received n-qubit quantum state using the one or more computational bases; and verifying the token measurement using the real measurement such that the quantum token is verified.

The quantum token verification method of the second aspect of the present disclosure may provide a means for an operator, such as a bank, for verifying a quantum token. The verification method may determine if a unique identifier is real, i.e., whether the unique identifier is an existing unique identifier, which may advantageously identify a forged token before using the quantum state. The verification method may subsequently utilise information known only to the operator, such as the secret-key quantum circuit, to determine what the quantum state of the quantum token should be, and may compare the real quantum state with the received quantum state, to determine whether the token has been forged.

In some embodiments, the classical computer determines that unique identifier is real by: comparing the unique identifier with a plurality of pre-existing unique identifiers; and determining that the unique identifier matches a pre-existing unique identifier of the plurality of unique identifiers. In this way, a forged quantum token may easily be identified when non-existent unique identifier is provided.

In some embodiments, the classical computer selects the secret-key quantum circuit by: selecting the secret-key quantum circuit from a plurality of pre-existing quantum circuits associated with the unique identifier. In this way, the operator may more easily determine the secret-key quantum circuit used to generate the quantum token, and therefore may more easily determine the real quantum state.

In some embodiments, the classical description comprises n portions, and generating the classical description comprises: generating a kth portion of the classical description by: initialising the n qubits of the secret-key quantum circuit according to a kth portion of the unique identifier; executing the secret-key quantum circuit; and measuring the secret-key quantum circuit; and combining the n portions. In this way, each of the portions of the classical description may be generated based on a respective portion of the unique identifier, such that the classical description is dependent on the unique identifier. The secret-key quantum circuit may be known only to an operator and as such, additional security may be provided since only the operator is able to reproduce the classical description based on the unique identifier.

In some embodiments, generating the real n-qubit quantum state comprises: generating, by the quantum computer, an n-qubit quantum circuit based on the one or more computational bases; and executing, by the quantum computer, the n-qubit quantum circuit so as to generate the n-qubit real quantum state. In this way, the n-qubit quantum state may be generated based on the classical description, which is itself generated using a secret-key quantum circuit known only to the operator. In this way, the n-qubit quantum state associated with a particular unique identifier may be reproducible by the operator only. Advantageously, the quantum token may be more secure.

In some embodiments, the real measurement is determined by: measuring, by the quantum computer, each qubit of the real quantum state according to a respective computational basis. In this way, the operator may be able to generate a string of bits representative of what the token measurement should be, each bit being an eigenstate of a respective computational basis.

In some embodiments, the token measurement is determined by: measuring, by the quantum computer, each qubit of the received quantum state according to a respective computational basis. In this way, the operator may be able to generate a string of bits representative of what the token measurement is. For this measurement, if the quantum token is invalid due to the quantum state being incorrect, the string of bits may not match the real measurement string, because each measured qubit may be output an incorrect measurement.

In some embodiments, the token measurement is verified by: comparing, by the classical computer, the token measurement to the real measurement; and determining, by the classical computer, that the token measurement is within a threshold difference. In this way, the token verification method may be robust to changes in the quantum state caused by, for example, a random quantum state change.

In some embodiments, the threshold difference is a Hamming distance threshold.

In some embodiments, the quantum token verification method further comprises: determining, by the classical computer, that the unique identifier is not real. In this way, a quantum token may be determined as being a forged quantum token, without having to determine the real quantum state, which may advantageously save computational resources.

In some embodiments, the classical computer determines that the unique identifier is not real by: comparing, by the classical computer, the unique identifier with a plurality of pre-existing unique identifiers; and determining, by the classical computer, that the unique identifier does not match a pre-existing unique identifier of the plurality of pre-existing unique identifiers.

In some embodiments, the quantum token verification method further comprises: presenting, by the classical computer on a display, a rejection indicator; and preferably further comprising: transmitting, by the classical computer to an external computing device, a notification indicating that a counterfeit token has been used.

In accordance with a third aspect of the present disclosure, there is provided a quantum token generation and verification method using a computing system comprising a quantum computer in communication with a classical computer, the method comprising the steps of: generating, using the classical computer, a unique identifier; determining, using the classical computer, a secret-key quantum circuit comprising n qubits; generating, using the classical computer and the quantum computer, a classical description of the unique identifier using the secret-key quantum circuit; wherein the classical description comprises n portions; generating, using the classical computer and the quantum computer, an n-qubit quantum state based on the classical description of the unique identifier; outputting, using the classical computer, a quantum token, the quantum token comprising: the unique identifier; and the n-qubit quantum state receiving, at the classical computer, the quantum token, the quantum token comprising: the unique identifier; and the n-qubit quantum state; determining, by the classical computer, that the unique identifier is real; selecting, by the classical computer, the secret-key quantum circuit; generating, by the classical computer and the quantum computer, the classical description of the unique identifier using the secret-key quantum circuit; determining, by the classical computer, one or more computational bases based on the classical description of the unique identifier; generating, by the quantum computer, a real n-qubit quantum state based on the classical description of the unique identifier and the one or more computational bases; determining, by the quantum computer, a real measurement of the real n-qubit quantum state using the one or more computational bases; determining, by the quantum computer, a token measurement of the received n-qubit quantum state using the one or more computational bases; and verifying the token measurement using the real measurement such that the quantum token is verified.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 is a quantum token generation method in accordance with a first aspect of the present disclosure;

FIG. 3 is an example secret-key quantum circuit;

FIG. 4 is an example quantum circuit; and

FIG. 5 is a quantum token verification method in accordance with a second aspect of the present invention.

### DETAILED DESCRIPTION

In classical computing, information is stored in bits that may be represented by either a ‘0’ or a ‘1’. In contrast, quantum computing represents data in quantum bits or ‘qubits’, which can occupy an infinite, continuous number of possible states, or a superposition of states.

A geometric representation of a quantum state of a qubit is the Bloch sphere, which is a sphere comprising two antipodal points, corresponding to orthogonal basis vectors |0 [symbol] and |1 [symbol] . A quantum state, |ψ [symbol] , of a qubit can be represented as a superposition of the basis vectors |0 [symbol] and |1 [symbol] , wherein the coefficient of each basis vector is a complex number, the square of which is a real number representative of a probability that the qubit is in the basis state (the total probability of the quantum state being 1).

A quantum state |ψ [symbol] may be represented as:

$$\vert ψ 〉 = cos ( \frac{θ}{2} ) \vert 0 〉 + {e}^{i ϕ} sin ( \frac{θ}{2} ) \vert 1 〉$$

An antipodal state |ψ′ [symbol] can be represented as:

$$\vert {ψ}^{′} 〉 = cos ( \frac{π - θ}{2} ) \vert 0 〉 - {e}^{i ( ϕ + π )} sin ( \frac{π - θ}{2} ) \vert 1 〉$$

Such that [symbol] ψ|ψ′ [symbol] =0, and {|ψ [symbol] , |ψ′ [symbol] } form a quantum basis.

As a further example, a quantum state |0 [symbol] may be represented as:

$$\vert θ 〉 = cos ( \frac{θ}{2} ) \vert 0 〉 + sin ( \frac{θ}{2} ) \vert 1 〉$$

An antipodal state |−θ [symbol] can be represented as:

$$\vert - θ 〉 = cos ( \frac{π - θ}{2} ) \vert 0 〉 - sin ( \frac{π - θ}{2} ) \vert 1 〉$$

Such that [symbol] θ|−θ [symbol] =0, and {|θ [symbol] , |−θ [symbol] } form a quantum basis.

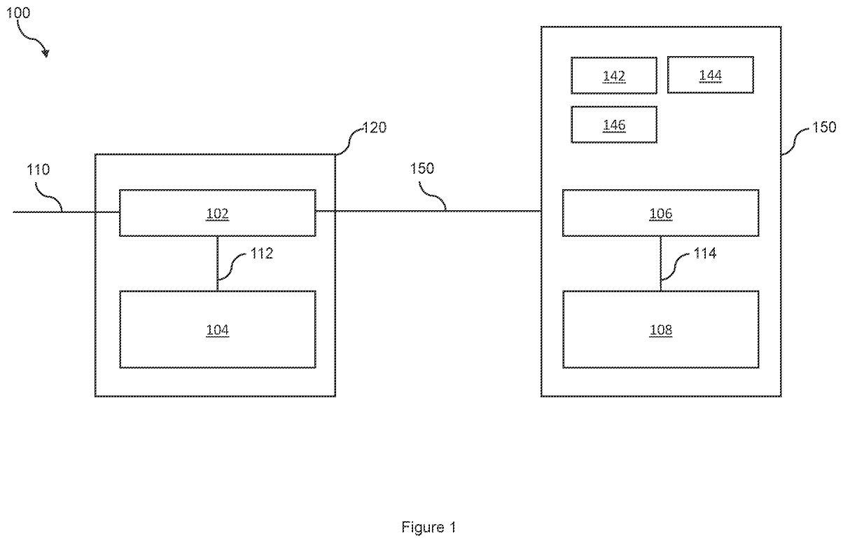

FIG. 1 shows a computing system 100 operated by an operator, such as a bank.

The computing system comprises a classical computer 130 coupled to a quantum computer 140 via an interface 150.

The classical computer 130 comprises a CPU 102 coupled to provide data to, and receive data from, a conventional memory 104 by means of a memory interface 112. Input information may be received by the CPU 102 from an interface 110. Output information may be provided by the CPU 102 to the interface 110. The classical computer 130 may further comprise additional classical computing elements as known in the art (not shown).

The conventional memory 104 comprises: a plurality of pre-existing unique identifiers; and a plurality of pre-existing quantum circuits, wherein each pre-existing quantum circuit is associated with a pre-existing unique identifier. In some embodiments, each pre-existing unique identifier is associated with a respective pre-existing unique quantum circuit, such that there is a one-to-one pairing for each identifier-circuit pair. Alternatively, each quantum circuit is associated with one or more pre-existing unique identifiers.

The conventional memory 104 is secure, such that only the operator (i.e. the bank) can access the plurality of pre-existing unique identifiers and the plurality of pre-existing quantum circuits.

The conventional memory 104 further comprises a computational basis key comprising a plurality of computational bases Γₓ corresponding to one or more respective binary strings. In the present example, each computational basis Γₓ corresponds to a respective 5-bit binary string. In particular, the computational basis key comprises a key of 5-bit strings of ‘0’ and ‘1’.

In the present example, the conventional memory 104 comprises 16 computational bases Γₓ, such that the configuration dictionary comprises 32 distinct values (i.e. two for each computational basis Γₓ). Furthermore, in the present example, the computational bases Γₓ are as follows:

$${Γ}_{1} = \{ \vert 0 〉 , \vert 1 〉 \}$$

$${Γ}_{2} = \{ \vert + 〉 , \vert - 〉 \}$$

$${Γ}_{3} = \{ \vert i 〉 , \vert - i 〉 \}$$

$${Γ}_{4} = \{ \vert \frac{π}{4} 〉 , \vert - \frac{π}{4} 〉 \}$$

$${Γ}_{5} = \{ \vert \frac{π}{6} 〉 , \vert - \frac{π}{6} 〉 \}$$

$${Γ}_{6} = \{ \vert \frac{π}{8} 〉 , \vert - \frac{π}{8} 〉 \}$$

$${Γ}_{7} = \{ \vert \frac{π}{12} 〉 , \vert - \frac{π}{12} 〉 \}$$

$${Γ}_{8} = \{ \vert \frac{π}{16} 〉 , \vert - \frac{π}{16} 〉 \}$$

$${Γ}_{9} = \{ \vert \frac{π}{20} 〉 , \vert - \frac{π}{20} 〉 \}$$

$${Γ}_{10} = \{ \vert \frac{π}{24} 〉 , \vert - \frac{π}{24} 〉 \}$$

$${Γ}_{11} = \{ \vert \frac{π}{28} 〉 , \vert - \frac{π}{28} 〉 \}$$

$${Γ}_{12} = \{ \vert \frac{π}{32} 〉 , \vert - \frac{π}{32} 〉 \}$$

$${Γ}_{13} = \{ \vert \frac{π}{36} 〉 , \vert - \frac{π}{36} 〉 \}$$

$${Γ}_{14} = \{ \vert \frac{π}{40} 〉 , \vert - \frac{π}{40} 〉 \}$$

$${Γ}_{15} = \{ \vert \frac{π}{44} 〉 , \vert - \frac{π}{44} 〉 \}$$

$${Γ}_{16} = \{ \vert \frac{π}{48} 〉 , \vert - \frac{π}{48} 〉 \}$$

It will be appreciated that the above computational basis Γₓ are examples, and that any computational basis Γₓ may be used. Furthermore, it will be appreciated that there may be any number of computational bases Γₓ. A higher number of computational bases Γₓ may advantageously increase the security of a quantum state generated based on the computational bases Γₓ. In particular, an increased number of computational bases Γₓ may advantageously reduce the chances of a quantum state being copied.

The quantum computer 140 comprises a quantum computing unit 106 and a quantum memory unit 108, a plurality of coupling devices 142, a bias device 144, and a state determination device 146. The quantum computer 140 may further comprise additional quantum computing elements as known in the art (not shown).

The quantum computing unit 106 comprises a number N of qubits. In the present example, the quantum computing unit 106 comprises 5 qubits, although it will be appreciated that the quantum computing unit 106 may comprise any number of qubits.

The qubits may be for example, superconducting flux devices having a circulating current. For example, the superconducting flux devices may comprise a loop of superconducting material interrupted by at least one Josephson junction, as is known in the art. Further qubit implementations may be envisaged.

The quantum computing unit 106 is configured to provide a quantum state of the qubits to the quantum memory unit 108 by means of a memory interface 114.

A “state” of the quantum computing unit 106 corresponds to the respective state of all of the N qubits. An example state of a qubit is a 0 state. The 0 state may correspond to, for example, a clockwise current around the superconducting flux devices which may induce a downward magnetic field. A counter clockwise current around the superconducting flux devices may induce an upwards magnetic field which references a state 1.

The state of the quantum computing unit 106 may be described by a bit string having a length N. Thus, there are 2^{N} possible configurations for the state of the quantum computing unit 106. In the present example, the quantum computing unit 106 comprises 5 qubits and thus there are 2⁵ possible configuration for the state of the quantum computing unit 106.

The quantum computer 140 is a quantum computer suitable for implementing a quantum circuit comprising one or more quantum gates. In the present example, the quantum computer 140 is suitable for implementing one or more quantum circuits comprising 5 qubits.

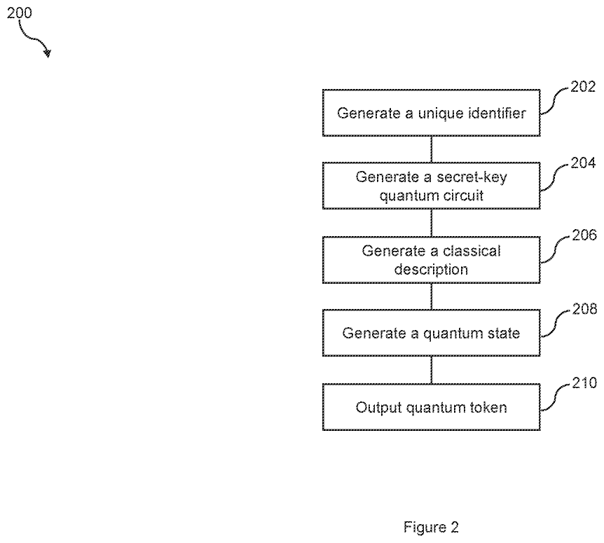

The following section provides a quantum token generation method 200 for generating a quantum token, as shown in FIG. 2. The method 200 is implemented using the computing system 100 including the classical computer 130 and the quantum computer 140.

The term “quantum token” may be understood as a token that may be used as a currency. In other words, the quantum token may be thought of as quantum money.

At step 202 of the method 200, the computing system 100 generates a unique identifier. In particular, the classical computer 130 randomly generates a unique identifier. The classical computer 130 randomly generates a unique identifier that is distinct from the plurality of pre-existing unique identifiers stored in the conventional memory 104.

In the present example, the unique identifier is a unique serial number, and more particularly a unique k-bit binary string. The classical computer 130 stores the generated unique identifier (unique serial number) in the plurality of pre-existing unique identifiers stored in the conventional memory 104.

For the following discussion of the method 200, an example k-bit binary string is a 5-bit binary string, although it will be appreciated that the binary string may be any length. In the present example, the unique serial number is 10010. It will be appreciated that the 5-bit binary unique serial number may be any permutation.

At step 204, the computing system 100 determines a secret-key quantum circuit comprising n qubits. In some embodiments, the classical computer 130 randomly selects a secret-key quantum circuit from the plurality of pre-existing quantum circuits stored in the conventional memory 104. In alternative embodiments, the classical computer 130 randomly generates a unique secret-key quantum circuit that is distinct from the plurality of pre-existing quantum circuits stored in the conventional memory 104. In such embodiments wherein the classical computer 130 randomly generates a unique secret-key quantum circuit, the classical computer 130 stores the unique secret-key quantum circuit in the plurality of pre-existing quantum circuits in the conventional memory 104.

The classical computer 130 also stores an indication that the unique secret-key quantum circuit is associated with the unique identifier generated in step 202. In this way, the unique secret-key quantum circuit may be more easily matched with the corresponding unique identifier in a verification process (such as the quantum token verification method 500 discussed below).

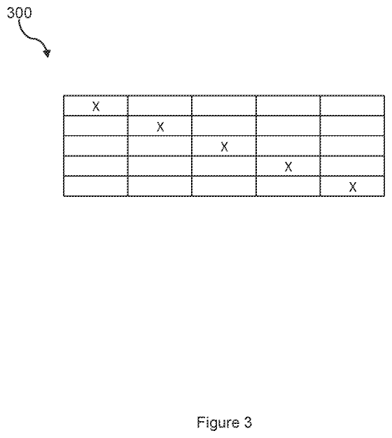

The secret-key quantum circuit comprises n qubits. An example secret-key quantum circuit 300 is shown in FIG. 3. The secret-key quantum circuit 300 of the present example comprises quantum circuits having 5 qubits. Each row is representative of a quantum circuit having 5 qubits. It will be appreciated that the present disclosure is not limited to a 5 qubit quantum circuit.

The secret-key quantum circuit 300 is a 5 by 5 identity matrix having a NOT gate on the diagonal. A first quantum circuit of the secret-key quantum circuit 300 is the first row of the secret-key quantum circuit 300, wherein an NOT gate is applied to the first qubit. The second quantum circuit is the second row, wherein an NOT gate is applied to the second qubit. The third quantum circuit is the third row, wherein an NOT gate is applied to the third qubit. The fourth quantum circuit is the fourth row, wherein an NOT gate is applied to the fourth qubit. The fifth quantum circuit is the fifth row, wherein an NOT gate is applied to the fifth qubit.

It will be appreciated that the secret-key quantum circuit 200 is an illustrative example, and the secret-key quantum circuit determined in step 204 is not limited to comprising NOT gates, may comprise any number of quantum gates, in any number of permutations.

It will be appreciated that steps 202 and 204 may be performed in parallel.

At step 206, the computing system 100 generates a classical description of the unique identifier generated in step 202 using the secret-key quantum circuit generated in step 204.

The classical description of the unique identifier comprises n portions. A k^{th} portion corresponds to a k^{th} bit of the unique serial number. To generate the k^{th} portion of the classical description, the quantum computer 140: initialises the qubits of the secret-key quantum circuit according to a k^{th} portion of the unique identifier (i.e. the k^{th} bit of the unique serial number); executes the secret-key quantum circuit; and measures the secret-key quantum circuit. Preferably, the secret-key quantum circuit is measured in the z-basis such that the output is a string of ‘0’ and ‘1’.

Continuing with the example secret key quantum circuit 300 of FIG. 3, each quantum circuit is initialised according to the serial number generated in step 202, such that each quantum circuit is initialised as |10010 [symbol] .

A first portion of the classical description is generated by: initialising the qubits of the first quantum circuit as |10010 [symbol] ; executing the first quantum circuit; and measuring the first quantum circuit in the z-basis. Accordingly, a NOT gate is applied to the first qubit of the first quantum circuit, and the first portion of the classical description is |00010 [symbol] .

A second portion of the classical description is generated by: initialising the qubits of the second quantum circuit as |10010 [symbol] ; executing the second quantum circuit; and measuring the second quantum circuit in the z-basis. Accordingly, a NOT gate is applied to the second qubit of the second quantum circuit, and the second portion of the classical description is |11010 [symbol] .

A third portion of the classical description is generated by: initialising the qubits of the third quantum circuit as |10010 [symbol] ; executing the third quantum circuit; and measuring the third quantum circuit in the z-basis. Accordingly, a NOT gate is applied to the third qubit of the third quantum circuit, and the third portion of the classical description is |10110 [symbol] .

A fourth portion of the classical description is generated by: initialising the qubits of the fourth quantum circuit as |10010 [symbol] ; executing the fourth quantum circuit; and measuring the fourth quantum circuit in the z-basis. Accordingly, a NOT gate is applied to the fourth qubit of the fourth quantum circuit, and the fourth portion of the classical description is |10000 [symbol] .

A fifth portion of the classical description is generated by: initialising the qubits of the fifth quantum circuit as |10010 [symbol] ; executing the fifth quantum circuit; and measuring the fifth quantum circuit in the z-basis. Accordingly, a NOT gate is applied to the fifth qubit of the fifth quantum circuit, and the fifth second portion of the classical description is |10011 [symbol] .

Accordingly, the classical description of the unique serial number is 0001011010101101000010011.

It will be appreciated that each portion of the classical description may be generated in series or parallel.

At step 208, the computing system 100 generates a quantum state based on the classical description of the unique identifier. To generate the quantum state the classical computer 130 determines one or more computational bases based on the classical description. The quantum computer 140 generates an n-qubit quantum circuit based on the one or more computational base. The quantum computer 140 executes the quantum circuit so as to generate the quantum state.

To determine the one or more computational bases, the classical computer 130 compares the classical description to the computational basis key. That is, the classical computer 130 compares each portion of n portions of the classical description to the computational basis key comprising the plurality of computational bases. The classical computer 130 then selects, for each portion of the plurality of portions of the classical description, a respective computational basis. The number of portions of the classical description is the same as the number of qubits of the quantum circuit such that each qubit has a corresponding computational basis.

In the present example, since the number of qubits is 5, and the classical description is a 25-bit binary string, each portion of the classical description is 5 bits in length. Accordingly, the classical computer 130 takes as input each 5-bit portion of the classical description, compares the 5-bit portion of the classical description to the configurational dictionary, and selects a computational basis using the configurational dictionary, wherein the corresponding computational basis is pre-determined and present in the configurational dictionary.

In the present example, the configurational dictionary provides:

$$config = \{ 00 \; 010 : + , 11010 : - , 10110 : \frac{π}{4} , 10000 : \frac{π}{6} , 10011 : \frac{π}{12} , … \} .$$

Therefore, the classical computer 130 selects: the computational basis |+ [symbol] for the first portion, the computational basis |− [symbol] for the second portion, the computational basis

$$\vert \frac{π}{4} 〉$$

for the third portion, the computational basis

$$\vert \frac{π}{6} 〉$$

for the fourth portion, and the computational basis

$$\vert \frac{π}{12} 〉$$

for the fifth portion.

To generate the quantum circuit, the quantum computer 140 initialises the quantum circuit as |00000 [symbol] , and applies one or more quantum gates to each qubit of the quantum circuit. The qubits are prepared in a quantum state according to a computational basis corresponding to a respective portion of the classical description. That is, the i^{th} qubit is prepared in the computational basis corresponding to the i^{th} portion of the classical description.

In the present example, the quantum computer 140 prepares: the first qubit in the computational basis |+ [symbol] , the second qubit in the computational basis |− [symbol] , the third qubit in the computational basis

$$\vert \frac{π}{4} 〉 ,$$

the fourth qubit in the computational basis

$$\vert \frac{π}{6} 〉 ,$$

and the fifth qubit in the computational basis

$$\vert \frac{π}{12} 〉 .$$

Accordingly, the quantum state corresponding to the classical description of this example is:

$$\vert ϕ 〉 = \vert + 〉 \vert - 〉 \vert \frac{π}{4} 〉 \vert \frac{π}{6} 〉 \vert \frac{π}{12} 〉$$

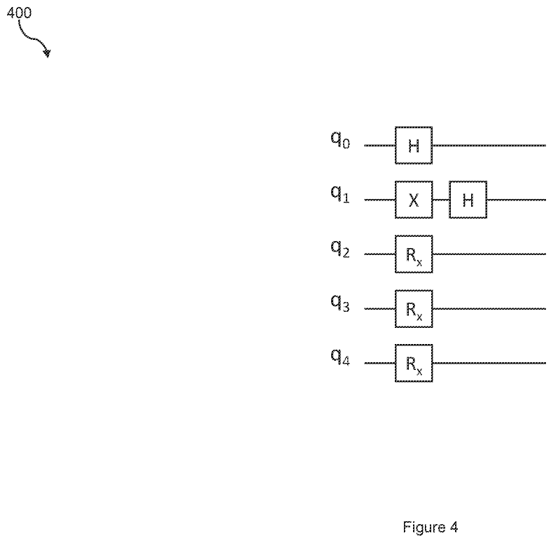

FIG. 4 shows an example quantum circuit 400 corresponding to the quantum state determined in step 208. The quantum circuit 400 comprises: a Hadamard gate on the first qubit; a NOT gate and a Hadamard gate on the second qubit; an

$${R}_{x} ( \frac{π}{4} )$$

on the third qubit, an

$${R}_{x} ( \frac{π}{6} )$$

on the fourth qubit, and an

$${R}_{x} ( \frac{π}{12} )$$

on the fourth qubit.

The n-qubit quantum state is generated by combining each qubit of the quantum circuit. The quantum state may be stored in a quantum memory.

At step 210, the computing system 100 outputs the quantum token. In particular, the computing system outputs the quantum token comprising the unique identifier (i.e. the unique serial number) generated in step 202, and the n-qubit quantum state generated in step 208. In the present example, the quantum token is:

$$QT = ( sn , \vert ϕ 〉 )$$

$$QT = ( 100 \; 10 , \vert + 〉 \vert - 〉 \vert \frac{π}{4} 〉 \vert \frac{π}{6} 〉 \vert \frac{π}{12} 〉 )$$

Accordingly, the secret-key quantum circuit generated in step 204 and the classical description generated in step 206.

Due to the no-cloning theorem, the quantum state generated in step 208 cannot be perfectly copied and as such, it is impossible to forge an exact copy of the quantum token.

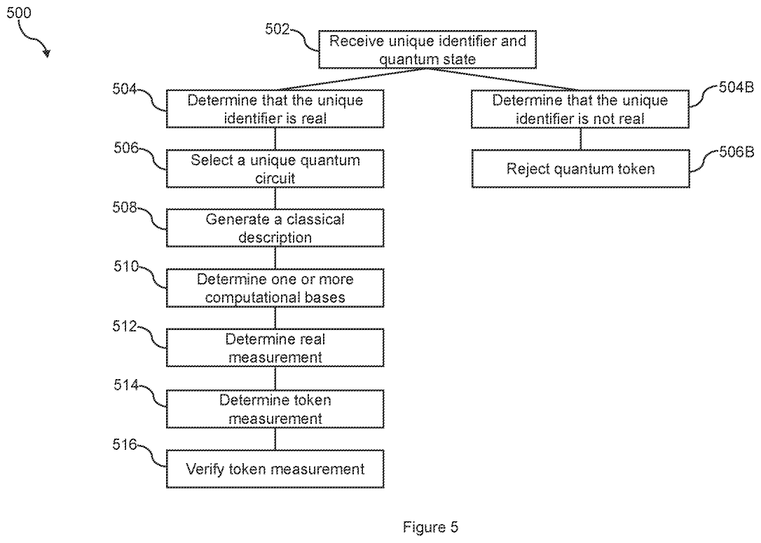

The following section provides a quantum token verification method 500 for generating a quantum token, as shown in FIG. 5. The method 500 is implemented using the computing system 100 including the classical computer 130 and the quantum computer 140. It will be appreciated that the classical computer 130 and the quantum computer 140 may be different to those used in the method 200, for example if the quantum token is verified at a separate system to the system used to generate the quantum token. This may be the case if, for example, the quantum token is generated at a first bank branch, and is verified at a separate second bank branch.

At step 502 of the method 500, the computing system 100 receives a quantum token, the quantum token comprising: a unique identifier, and an n-qubit quantum state. In particular, the classical computer 130 receives the unique identifier and the n-qubit quantum state. For example, the classical computer 130 receives the unique identifier and the n-qubit quantum state via the interface 110. The unique identifier may be the unique identifier generated in step 202 (i.e. the unique serial number), and the n-qubit quantum state may be the n-qubit quantum state generated in step 208. Accordingly, in the present example, the quantum token received is:

$$QT = ( 100 \; 10 , \vert + 〉 \vert - 〉 \vert \frac{π}{4} 〉 \vert \frac{π}{6} 〉 \vert \frac{π}{12} 〉 )$$

At step 504, the computing system 100 determines that the unique identifier (i.e. the unique serial number) is real. In particular, the classical computer 130 determines that the unique identifier is real by comparing the unique identifier with the plurality of pre-existing unique identifiers stored on the conventional memory 104. The classical computer 130 determines that the unique identifier matches a pre-existing unique identifier of the plurality of pre-existing unique identifiers stored on the conventional memory.

Alternatively, at step 504B, the classical computer 130 determines that the unique identifier is not real. For example, the classical computer 130 compares the unique identifier received in step 502 with the plurality of pre-existing unique identifiers stored in the conventional memory 104, and determines that the unique identifier does not match a pre-existing unique identifier of the plurality of pre-existing unique identifiers.

If the classical computer 130 determines in step 504B that the unique identifier is not real, the method 500 instead proceeds to an alternative step 506B. In the alternative step 506B, the classical computer 130 rejects the quantum token, for example by presenting, on a display (not shown), a rejection indicator. For example, the classical computer 130 may present, on the display, “Invalid Serial Number”.

In the alternative step 506B, the classical computer 130 may also transmit a notification to a third party, such as local authorities indicating that a counterfeit token has been used. In particular, the classical computer 130 may be communicatively coupled to an external computing device (not shown) associated with the local authorities, such that the classical computer 130 automatically transmits the notification to the local authorities indicating that a counterfeit token has been used.

At step 506, the computing system 100 selects a secret-key quantum circuit. In particular, the classical computer 130 selects the secret-key quantum circuit from the plurality of pre-existing quantum circuits stored in the conventional memory 104. The classical computer 130 selects the secret-key quantum circuit of the plurality of pre-existing quantum circuits associated with the unique identifier received in step 502. For example, in the present case wherein the unique identifier is the unique serial number generated in step 202, the secret-key quantum circuit selected in step 506 is the secret-key quantum circuit generated in step 204 (i.e. the quantum circuit 300).

At step 508, the computing system 100 generates a classical description of the unique identifier (i.e. the unique serial number) received in step 502 using the secret-key quantum circuit selected in step 506. The quantum computer 140 initiates and executes the secret-key quantum circuit based on the unique serial number, according to the scheme discussed in relation to step 206, so as to generate the classical description of the quantum token. Continuing with the present example, the classical description of the quantum token is 0001011010101101000010011.

At step 510, the computing system 100 determines one or more computational bases based on the classical description of the unique identifier. The classical computer determines the one or more computational bases using the computational basis key comprising the plurality of computational bases stored on the conventional memory 104. In particular, the classical computer 130 compares each portion of n portions of the classical description to the computational basis key comprising the plurality of computational bases. The classical computer 130 then selects, for each portion of the plurality of portions of the classical description, a respective computational basis. Continuing with the present example, the classical computer 130 selects: the computational basis |+ [symbol] for the first portion, the computational basis |− [symbol] for the second portion, the computational basis

$$\vert \frac{π}{4} 〉$$

for the third portion, the computational basis

$$\vert \frac{π}{6} 〉$$

for the fourth portion, and the computational basis

$$\vert \frac{π}{12} 〉$$

for the fifth portion

At step 512, the computing system 100 generates a real n-qubit quantum state based on the classical description of the unique identifier determined in step 508 and the one or more computational bases determined in step 510. In particular, the quantum computer 140 generates an n-qubit quantum circuit based on the one or more computational bases; and executes the n-qubit quantum circuit so as to generate the real n-qubit quantum state.

To generate the quantum circuit, the quantum computer 140 initialises the quantum circuit as |00000 [symbol] , and applies one or more quantum gates to each qubit of the quantum circuit. The qubits are prepared in a quantum state according to a computational basis corresponding to a respective portion of the classical description. That is, the i^{th} qubit is prepared in the computational basis corresponding to the i^{th} portion of the classical description. In the present example, the quantum computer 140 prepares: the first qubit in the computational basis |+ [symbol] , the second qubit in the computational basis |− [symbol] , the third qubit in the computational basis

$$\vert \frac{π}{4} 〉 ,$$

the fourth qubit in the computational basis

$$\vert \frac{π}{6} 〉 ,$$

and the fifth qubit in the computational basis

$$\vert \frac{π}{12} 〉 .$$

In this way, the real quantum state is the quantum state determined in step 208.

The real n-qubit quantum state is the quantum state generated using the unique identifier and the secret-key quantum circuit. In this way, the operator is able to re-construct the correct quantum state using the unique identifier of the quantum token received in step 502.

At step 514, the computing system 100 determines a real measurement of the real n-qubit quantum state determined in step 512 using the one or more computational bases determined in step 510. In particular, the quantum computer 140 measures each qubit of the real quantum state according to the respective computational basis. In this way, the operator is able to generate a string of bits representative of what a token measurement should be, each bit being an eigenstate of a respective computational basis.

At step 516, the computing system 100 determines a token measurement of the received quantum state received in step 502 using the one or more computational bases determined in step 510. In particular, the quantum computer 140 measures each qubit of the received quantum state according to the respective computational basis. In this way, the operator is able to generate a string of bits representative of what the token measurement is. For this measurement, if the quantum token is invalid due to the quantum state being incorrect, the string of bits will not match the real measurement string, because each measured qubit may be output an incorrect measurement.

At step 518, the computing system 100 verifies the token measurement determined in step 516 using the real measurement determined in step 514 such that the quantum token is verified. The classical computer 130 verifies the token measurement by comparing the token measurement to the real measurement, and determining that the token measurement is within a threshold difference.

In the present example, the classical computer 130 compares the bit string of the token measurement with the bit string of the real measurement; and determines that the token measurement is within the threshold difference.

In some embodiments, the classical computer 130 determines a Hamming distance between the token measurement and the real measurement, and determines that the real measurement matches the real measurement if the Hamming distance is less than a Hamming distance threshold. It will be appreciated that any method for determining a difference between two strings may be used. In this way, noise affecting the quantum state of the quantum token may be accounted for.

Following verification of the token measurement in step 516, the quantum token is verified.

If it is determined that the token measurement does not match the real measurement, for example if the Hamming distance exceeds the Hamming distance threshold, the classical computer 130 rejects the quantum token, and transmits a communication to a third party, such as local authorities indicating that a counterfeit token has been used.

Accordingly, the quantum token verification method 500 requires knowledge of a secret-key quantum circuit, such as the secret-key quantum circuit generated in step 204 so as to generate a classical description, such as the classical description generated in step 206.

Some embodiments may assign computer processing tasks to recipient processors, for example, but not limited to CPUs, GPUs, DSPs, GP-GPUs, quantum processor and/or processors optimised for artificial intelligence tasks. In such embodiments, the processors are the recipients and the processing tasks are the opportunities. In such embodiments, in for example, a complex cloud computing infrastructure a large number of tasks, of differing types, requiring execution may be received and a large number of processors may be housed within the cloud computing infrastructure.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A quantum token generation method using a computing system comprising a quantum computer in communication with a classical computer, the method comprising the steps of:
generating, using the classical computer, a unique identifier;
determining, using the classical computer, a secret-key quantum circuit comprising n qubits;
generating, using the classical computer and the quantum computer, a classical description of the unique identifier using the secret-key quantum circuit;
wherein the classical description comprises n portions;
generating, using the classical computer and the quantum computer, an n-qubit quantum state based on the classical description of the unique identifier; and
outputting, using the classical computer, a quantum token, the quantum token comprising:
the unique identifier; and
the n-qubit quantum state.

2. The quantum token generation method of claim 1, wherein the classical description comprises n portions, and generating the classical description comprises:
generating a kth portion of the classical description by:
initialising the n qubits of the secret-key quantum circuit according to a kth portion of the unique identifier;
executing the secret-key quantum circuit; and
measuring the secret-key quantum circuit; and
combining the n portions.

3. The quantum token generation method of claim 1, wherein generating the n-qubit quantum state comprises:
determining, by the classical computer, one or more computational bases based on the classical description;
generating, by the quantum computer, an n-qubit quantum circuit based on the one or more computational bases; and
executing, by the quantum computer, the n-qubit quantum circuit so as to generate the n-qubit quantum state.

4. The quantum token generation method of claim 1, wherein generating the unique identifier comprises:
randomly selecting a unique identifier; wherein the unique identifier is distinct from a plurality of pre-existing unique identifiers.

5. The quantum token generation method of claim 4, further comprising:
storing, using the classical computer, the unique identifier in the plurality of pre-existing unique identifiers.

6. The quantum token generation method of claim 1, wherein determining the secret-key quantum circuit comprises:
randomly selecting, by the classical computer, the secret-key quantum circuit from a plurality of pre-existing quantum circuits.

7. The quantum token generation method of claim 1, wherein the unique identifier is a k-bit binary string serial number; wherein the classical description is a k×n bit binary string.

8. A quantum token verification method using a computing system comprising a classical computer in communication with a quantum computer, the method comprising the steps of:
receiving, at the classical computer, a quantum token, the quantum token comprising:
a unique identifier; and
an n-qubit quantum state;
determining, by the classical computer, that the unique identifier is real;
selecting, by the classical computer, a secret-key quantum circuit;
generating, by the classical computer and the quantum computer, a classical description of the unique identifier using the secret-key quantum circuit;
determining, by the classical computer, one or more computational bases based on the classical description of the unique identifier;
generating, by the quantum computer, a real n-qubit quantum state based on the classical description of the unique identifier and the one or more computational bases;
determining, by the quantum computer, a real measurement of the real n-qubit quantum state using the one or more computational bases;
determining, by the quantum computer, a token measurement of the received n-qubit quantum state using the one or more computational bases; and
verifying the token measurement using the real measurement such that the quantum token is verified.

9. The quantum token verification method of claim 8, wherein the classical computer determines that the unique identifier is real by:
comparing the unique identifier with a plurality of pre-existing unique identifiers; and
determining that the unique identifier matches a pre-existing unique identifier of the plurality of pre-existing unique identifiers.

10. The quantum token verification method of claim 8, wherein the classical computer selects the secret-key quantum circuit by:
selecting the secret-key quantum circuit from a plurality of pre-existing quantum circuits associated with the unique identifier.

11. The quantum token verification method of claim 8, wherein the classical description comprises n portions, and generating the classical description comprises:
generating a kth portion of the classical description by:
initialising the n qubits of the secret-key quantum circuit according to a kth portion of the unique identifier;
executing the secret-key quantum circuit; and
measuring the secret-key quantum circuit; and
combining the n portions.

12. The quantum token verification method of claim 8, wherein generating the real n-qubit quantum state comprises:
generating, by the quantum computer, an n-qubit quantum circuit based on the one or more computational bases; and
executing, by the quantum computer, the n-qubit quantum circuit so as to generate the n-qubit real quantum state.

13. The quantum token verification method of claim 8, wherein the real measurement is determined by:
measuring, by the quantum computer, each qubit of the real quantum state according to a respective computational basis; wherein the token measurement is determined by:
measuring, by the quantum computer, each qubit of the received quantum state according to a respective computational basis.

14. The quantum token verification method of claim 8, further comprising:
determining, by the classical computer, that the unique identifier is not real; wherein the classical computer determines that the unique identifier is not real by:
comparing, by the classical computer, the unique identifier with a plurality of pre-existing unique identifiers; and
determining, by the classical computer, that the unique identifier does not match a pre-existing unique identifier of the plurality of pre-existing unique identifiers.

15. A quantum token generation and verification method using a computing system comprising a quantum computer in communication with a classical computer, the method comprising the steps of:
generating, using the classical computer, a unique identifier;
determining, using the classical computer, a secret-key quantum circuit comprising n qubits;
generating, using the classical computer and the quantum computer, a classical description of the unique identifier using the secret-key quantum circuit;
wherein the classical description comprises n portions;
generating, using the classical computer and the quantum computer, an n-qubit quantum state based on the classical description of the unique identifier;
outputting, using the classical computer, a quantum token, the quantum token comprising:
the unique identifier; and
the n-qubit quantum state
receiving, at the classical computer, the quantum token, the quantum token comprising:
the unique identifier; and
the n-qubit quantum state;
determining, by the classical computer, that the unique identifier is real;
selecting, by the classical computer, the secret-key quantum circuit;
generating, by the classical computer and the quantum computer, the classical description of the unique identifier using the secret-key quantum circuit;
determining, by the classical computer, one or more computational bases based on the classical description of the unique identifier;
generating, by the quantum computer, a real n-qubit quantum state based on the classical description of the unique identifier and the one or more computational bases;
determining, by the quantum computer, a real measurement of the real n-qubit quantum state using the one or more computational bases;
determining, by the quantum computer, a token measurement of the received n-qubit quantum state using the one or more computational bases; and
verifying the token measurement using the real measurement such that the quantum token is verified.

16. The quantum token generation method of claim 3, wherein determining the one or more computational bases comprises:
comparing, by the classical computer, each portion of n portions of the classical description to a computational basis key comprising a plurality of computational bases; and
selecting, for each portion of the plurality of portions of the classical description, a respective computational basis.

17. The quantum token generation method of claim 16, wherein generating the quantum circuit comprises:
preparing, by the quantum computer, each qubit of the n-qubit quantum circuit in a computational basis corresponding to a respective portion of the classical description;
wherein an i^{th} qubit is initialized in the computational basis corresponding to the i^{th} portion of the classical description.

18. The quantum token generation method of claim 1, wherein determining the secret-key quantum circuit comprises:
randomly generating, by the classical computer, a unique secret-key quantum circuit that is distinct from a plurality of pre-existing quantum circuit;
the method further comprising:
storing, by the classical computer, an indication that the secret-key quantum circuit is associated with the unique identifier.

19. The quantum token verification method of claim 13, wherein the token measurement is verified by:
comparing, by the classical computer, the token measurement to the real measurement; and
determining, by the classical computer, that the token measurement is within a threshold difference.

20. The quantum token verification method of claim 14, further comprising:
presenting, by the classical computer on a display, a rejection indicator; and
transmitting, by the classical computer to an external computing device, a notification indicating that a counterfeit token has been used.
